(19) United States
(12) Patent Application Publication
(10) Pub. No.: US 2026/0209487 A1
(43) Pub. Date: Jul. 23, 2026

(54) A METHOD FOR IMPROVING THE PROCESSING OF POLYETHYLENE

(71) Applicant: BASF SE, Ludwigshafen am Rhein (DE)

(72) Inventors: Daniel Mueller, Kaisten (CH); Heinz Herbst, Kaisten (CH); Wiebke Wunderlich-Wippert, Kaisten (CH); Michèle Gerster, Basel (CH)

(73) Assignee: BASF SE, Ludwigshafen am Rhein (DE)

(21) Appl. No.: 19/140,194

(22) PCT Filed: Dec. 21, 2023
(86) PCT No.: PCT/EP2023/087245

§ 371 Date: Jun. 17, 2025

(30) Foreign Application Priority Data
Dec. 21, 2022 (EP) 22215247.2

(51) Int. Cl. C08L 23/04; C08K 5/32

(52) U.S. Cl. CPC C08L 23/04; C08K 5/32; C08L 2203/12; C08L 2203/16; C08L 2205/025; C08L 2205/03; C08L 2205/06; C08L 2207/066; C08L 2207/20

(57) ABSTRACT

The present invention relates to a method for increasing drawability and/or melt strength and/or melt elasticity of polyethylene including the step of mixing the polyethylene with a compound selected from polypropylene, at least one hydroxylamine ester of the formula (I), or a combination thereof. The present invention further relates to a polyethylene composition including polyethylene, and a compound selected from polypropylene, hydroxylamine esters of the formula (I), (IA), (IA′), (IA″), (IA′″), or mixtures of two or more thereof, or combination thereof. The present invention also relates to the use of polypropylene and/or hydroxylamine esters of the formula (I), (IA), (IA′), (IA″), (IA′″), or mixtures of two or more thereof for increasing the drawability and/or melt strength and/or melt elasticity of polyethylene.

### FIELD OF THE INVENTION

The present invention relates to a method for increasing drawability and/or melt strength and/or melt elasticity of polyethylene comprising the step of mixing the polyethylene with a compound selected from polypropylene, at least one hydroxylamine ester of the formula (I), or combination thereof. The present invention further relates to a polyethylene composition comprising polyethylene, and a compound selected from polypropylene, hydroxylamine esters of the formula (I), (IA), (IA′), (IA″), (IA′″), or mixtures of two or more thereof, or combination thereof. The present invention also relates to a use of polypropylene and/or hydroxylamines esters of the formula (I), (IA), (IA′), (IA″), (IA′″), or mixtures of two or more thereof for increasing the drawability and/or melt strength and/or melt elasticity of polyethylene.

### BACKGROUND OF THE INVENTION

Polyethylene can be used in a wide variety of applications. Typically, this can include a number of different articles such as films, extrudates and pipes and many more. Different types of polyethylene can be produced by a number of processes including low density polyethylene (LDPE), linear low density polyethylene (LLDPE), high density polyethylene (HDPE).

Polyethylene may for instance be processed by blown moulding, blown film or by the extrusion techniques. During such processing techniques, especially for blown moulding, blown film and extrusion, properties such as melt strength and melt elasticity are often important. Properties such as drawability can also be important during the processing of polyethylene, especially when producing fibres, typically as spun melt or continuous filaments, or when producing blown films, typically involving extrusion of the polyethylene through a blown film extruder machine.

US 2011/0171407 A1 discloses a method for increasing the melt strength of a polyethylene resin by reacting the polyethylene resin with an alkoxy amine derivative of the formula: (R₁) (R₂) N—O—R₃ where R₁ and R₂ are each independently of one another hydrogen, C₄-C₄₂ alkyl or C₄-C₄₂ aryl or substituted hydrocarbon groups comprising O and/or N, and where R₁ and R₂ may form a ring structure together; and where R₃ is hydrogen, a hydrocarbon or a substituted hydrocarbon group comprising O and/or N. This disclosure recognised that melt strength is a practical measurement that can predict material performance when submitted at elongational deformations.

U.S. Pat. No. 7,030,196 B2 relates to the use of hydroxylamine esters as polymerization initiators and to the use of hydroxylamine esters for the controlled degradation of polypropylene and for the controlled build-up of the molecular weight or cross-linking of polyethylene. The use examples show under item C) controlled degradation of polypropylene by means of hydroxylamine esters (NOR compounds). Addition of an NOR compound results in the polypropylene used undergoing increased degradation, which is reflected in higher MFR values compared with the starting polymer. In contrast to the alkylated hydroxylamines, the hydroxylamine esters produce considerably greater polymer degradation (higher MFR values at the same use concentration).

An objective of the present invention is to provide a method for increasing drawability and/or melt strength and/or melt elasticity of polyethylene. In particular, there is a desire to increase melt strength and/or melt elasticity and/or drawability of polyethylene during processing, especially during the extrusion of polyethylene, and more especially during the extrusion of polyethylene to produce films or fibers. This would particularly be the case for blown polyethylene film production. Such improvements are desirable for mono oriented polyethylene films (MOPE) and biaxial orientated polyethylene films (BOPE).

### SUMMARY OF THE INVENTION

Surprisingly, it has been found that the polypropylene and hydroxylamine esters of the formula (I), (IA), (IA′), (IA″), (IA′″), or mixtures of two or more thereof when mixed with the polyethylene, increases the drawability and/or melt strength and/or melt elasticity of the polyethylene.

Thus, in one aspect, the presently claimed invention is directed to a method for increasing the drawability and/or melt strength and/or melt elasticity of polyethylene comprising the step of mixing the polyethylene with from 0.1 to 10 wt % of polypropylene based on the total weight of the mixture, and at least one hydroxylamine ester of the formula (I), or a combination thereof.

In another aspect, the presently claimed invention is directed to a polyethylene composition comprising 80 to 99.8 wt % of polyethylene based on the total weight of the composition; and from 0.1 to 10 wt % of a polypropylene based on the total weight of the composition, and 0.001 to 1 wt % of hydroxylamine esters selected from sterically hindered amine of the formula (I), (IA), (IA′), (IA″), (IA′″), or mixtures of two or more thereof based on the total weight of the composition.

In yet another aspect, the presently claimed invention is directed to the use of polypropylene and hydroxylamine esters selected from sterically hindered amine of the formula (I), (IA), (IA′), (IA″), (IA′″), or mixtures of two or more thereof, for increasing the drawability and/or melt strength and/or melt elasticity of polyethylene.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “a preferred embodiment” means that a particular feature, structure or characteristic described in connection with the embodiment is included in at least one embodiment of the presently claimed invention. Thus, appearances of the phrases “in one embodiment” or “in a preferred embodiment” or “in another embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e., a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the presently claimed invention is directed to a method for increasing drawability and/or melt strength and/or melt elasticity of polyethylene comprising the step of mixing the polyethylene with a compound selected from 0.1 to 10 wt % of polypropylene based on the total weight of the mixture, at least one hydroxylamine ester of the formula (I), or a combination thereof

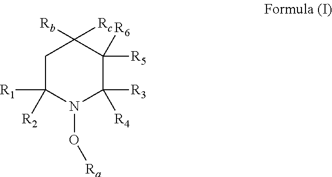

wherein Rₐ represents acyl;
one of R_{b} and R_{c} represents hydrogen, hydroxyl, or C₁-C₆alkyl and the other is C₁-C₆alkyl, C₁-C₆alkoxy, C₆-C₁₀aryloxy, acyloxy selected from the group consisting of —O—C(═O)—H, —O—C(═O)C₁-C₁₉alkyl, —O—C(═O)—C₁-C₅₄alkenyl, —O—C(═O)—C₆-C₁₀aryl, —O—C(═O)—C₁-C₃₆alkenyl-C₆-C₁₀aryl, —O—C(═O)—O—C₁-C₁₉alkyl, —O—C(═O)—O—C₆-C₁₀aryl, —O—C(═O)—NH—C₁-C₆alkyl, —O—C(═O)—NH—C₆-C₁₀aryl and —O—C(═O)—N(C₁-C₆alkyl)₂, C₁-C₆alkylamino, di-C₁-C₆alkylamino, C₆-C₁₀arylamino, acylamino selected from the group consisting of —NH—C(═O)—H, —NH—C(═O)—C₁-C₁₉alkyl, —NH—C(═O)C₁-C₅₄alkenyl, —NH—C(═O)—C₆-C₁₀aryl, —NH—C(═O)—C₁-C₃₆alkenyl-C₆-C₁₀aryl, —NH—C(═O)—O—C₁-C₁₉alkyl, —NH—C(═O)—O—C₆-C₁₀aryl, —NH—C(═O)—NH—C₁-C₆alkyl, —NH—C(═O)—NH—C₆-C₁₀aryl and —NH—C(═O)—N(C₁-C₆alkyl)₂, diacylamino selected from the group consisting of —N[—C(═O)—C₁-C₁₉alkyl]₂ and —N[—C(═O)—C₆-C₁₀aryl]₂, or N-acyl-N—C₁-C₆alkylamino; or
R_{b} and R_{c} both represent hydrogen, hydroxyl, or identical or different substituents as defined above; or
R_{b} and R_{c} are 5 membered or 6 membered rings of the general formula

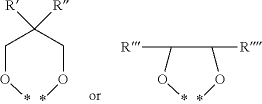

wherein, (*) indicates the position of attachment,
R′, and R′″ are C₁-C₄ alkyl, and
R″, and R″″ are C₁-C₄alkylene-hydroxy, C₄-C₃₂acyloxy, or C₄-C₃₂acyloxy-C₁-C₄alkylene;
R₁-R₄ each represent independently of one another C₁-C₆alkyl; and
R₅ and R₆ each represent independently of one another hydrogen, C₁-C₆alkyl or
C₆-C₁₀aryl; or
R₅ and R₆ together represent oxygen. In an embodiment, the method for increasing the drawability and/or melt strength and/or melt elasticity of polyethylene comprises the step of mixing the polyethylene with 0.1 to 10 wt % of polypropylene based on the total weight of the mixture.

In an embodiment, the method of increasing drawability and/or melt strength and/or melt elasticity of polyethylene comprises the step of mixing the polyethylene with at least one hydroxylamine ester of the formula (I).

In an embodiment, the method of increasing drawability and/or melt strength and/or melt elasticity of polyethylene comprises the step of mixing the polyethylene with 0.001 to 1 wt % of at least one hydroxylamine ester of the formula (I) based on the total weight of the mixture. In an embodiment, the method for increasing the drawability and/or melt strength and/or melt elasticity of polyethylene comprising the step of mixing the polyethylene with polypropylene and at least one hydroxylamine ester of the formula (I).

In another embodiment, the method for increasing the drawability and/or melt strength and/or melt elasticity of polyethylene comprising the step of mixing the polyethylene, and a compound selected from 0.1 to 10 wt % of polypropylene based on the total weight of the mixture, 0.001 to 1 wt % of at least one hydroxylamine ester of the formula (I) based on the total weight of the mixture, or a combination thereof.

### Polyethylene:

In an embodiment, the polyethylene is ultra-high molecular weight polyethylene (UHMWPE), ultra-low molecular weight polyethylene (ULMWPE or PE-WAX), high molecular weight polyethylene (HMWPE), high density polyethylene (HDPE), high density cross-linked polyethylene (HDXLPE), cross-linked polyethylene (PEX or XLPE), medium density polyethylene (MDPE), linear low-density polyethylene (LLDPE), low density polyethylene (LDPE), very low-density polyethylene (VLDPE), or chlorinated polyethylene (CPE).

In a preferred embodiment, the polyethylene is ultra-high molecular weight polyethylene (UHMWPE), high density polyethylene (HDPE), linear low-density polyethylene (LLDPE), low-density polyethylene (LDPE), or medium density polyethylene (MDPE).

In a more preferred embodiment, the polyethylene is a linear low-density polyethylene (LLDPE), or low-density polyethylene (LDPE).

In an embodiment, the polyethylene has a density of from 0.910 to 0.960 g/cm³, preferably from 0.915 to 0.950 g/cm³.

The polyethylene is an ultra-high molecular weight polyethylene (UHMWPE). Such UHMWPE has a molecular weight of several million, for instance from 3.5 to 7.5 million g/mol. Typically, the density tends to be less than high density polyethylene and can be in the range of from 0.930 to 0.935 g/cm³.

High density polyethylene (HDPE) can also be processed in accordance with the present invention, especially if the density does not exceed 0.960 g/cm³. Typically, HDPE has a density of greater than 0.941 g/cm³.

LLDPE can be characterized by being a substantially linear polymer but can have numerous short branches. The density of LLDPE is typically in the range of from 0.915 to 0.925 g/cm³.

Low density polyethylene can be characterized by having a high degree of short and long chain branching. Typically, LDPE can have a density in the range of from 0.910 to 0.940 g/cm³. Where LDPE is been processed, desirably the density is in the range of from 0.915 to 0.940 g/cm³.

Suitably the polyethylene employed in accordance with the present invention can be a medium density polyethylene (MDPE). Typically, such a medium density polyethylene (MDPE) has a density in the range of from 0.926 to 0.940 g/cm³.

In an embodiment, the polyethylene is recyclate.

In another embodiment, the polyethylene is virgin polyethylene, polyethylene recyclate, or mixtures thereof.

Polyethylene recyclate can contain other polymers, such as polyolefins.

Polyethylene recyclate can be obtainable from domestic, commercial and industrial waste or from useful material collections. The recycled polyethylene can originate from separation and sorting, or from specific industrial sectors and return obligations, for example from the automobile industry, electrical/electronic industry, construction, agriculture and the textile industry, or from households and commerce (for example supermarkets).

### Polypropylenes:

In an embodiment, the polypropylene is selected from the group consisting of polypropylene homopolymers, or polypropylene copolymers.

In an embodiment, the polypropylene has a melt flow index of greater than or equal to 0.5 g/10 min.

In a preferred embodiment, the polypropylene has a melt flow index of greater than or equal to 2 g/10 min.

In a more preferred embodiment, the polypropylene has a melt flow index in the range of from 0.5 to 2500 g/10 min.

In a most preferred embodiment, the polypropylene has a melt flow index in the range of from 2 to 2500 g/10 min.

Melt flow indexes (MFI) were measured at 230° C. with a 2.16 kg load according to EN ISO 1133.

In an embodiment, the weight ratio of the total amount of polypropylene to the total amount of polyethylene is in the range of from 0.5:99.5 to 10:90.

In a preferred embodiment, the weight ratio of the total amount of polypropylene to the total amount of polyethylene is in the range of from 1:99 to 5:95.

The present polypropylene type polymers to be degraded may encompass propylene homopolymers, or propylene copolymers. Propylene copolymers can contain various proportions, for example up to about 90%, or up to about 50% of comonomers. Examples of comonomers such are: olefins such as 1-olefins, e.g., ethylene, 1-butene, 1-pentene, 1-hexene, 1-heptene or 1-octene, isobutylene; cycloolefins, e.g., cyclopentene, cyclohexene, norbornene or ethylidene norbornene; dienes such as butadiene, isoprene, 1,4-hexadiene, cyclopentadiene, dicyclopentadiene or norbornadiene; and also acrylic acid derivatives and unsaturated carboxylic anhydrides such as maleic anhydride.

### Hydroxylamine Esters:

In an embodiment, the at least one hydroxylamine ester of the formula (I) is as follows:

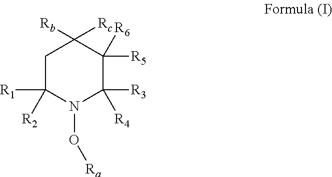

wherein Rₐ represents acyl;
one of R_{b} and R_{c} represents hydrogen, hydroxyl, or C₁-C₆alkyl and the other is C₁-C₆alkyl, C₁-C₆alkoxy, C₆-C₁₀aryloxy, acyloxy selected from the group consisting of —O—C(═O)—H, —O—C(═O)C₁-C₁9alkyl, —O—C(═O)—C₁-C₅₄alkenyl, —O—C(═O)—C₆-C₁₀aryl, —O—C(═O)—C₁-C₃₆alkenyl-C₆-C₁₀aryl, —O—C(═O)—O—C₁-C₁₉alkyl, —O—C(═O)—O—C₆-C₁₀aryl, —O—C(═O)—NH—C₁-C₆alkyl, —O—C(═O)—NH—C₆-C₁₀aryl and —O—C(═O)—N(C₁-C₆alkyl)₂, C₁-C₆alkylamino, di-C₁-C₆alkylamino, C₆-C₁₀arylamino, acylamino selected from the group consisting of —NH—C(═O)—H, —NH—C(═O)—C₁-C₁₉alkyl, —NH—C(═O)C₁-C₅₄alkenyl, —NH—C(═O)—C₆-C₁₀aryl, —NH—C(═O)—C₁-C₃₆alkenyl-C₆-C₁₀aryl, —NH—C(═O)—O—C₁-C₁₉alkyl, —NH—C(═O)—O—C₆-C₁₀aryl, —NH—C(═O)—NH—C₁-C₆alkyl, —NH—C(═O)—NH—C₆-C₁₀aryl and —NH—C(═O)—N(C₁-C₆alkyl)₂, diacylamino selected from the group consisting of —N[—C(═O)—C₁-C₁₉alkyl]₂ and —N[—C(═O)—C₆-C₁₀aryl]₂, or N-acyl-N—C₁-C₆alkylamino; or
R_{b} and R_{c} both represent hydrogen, hydroxyl, or identical or different substituents as defined above; or
R_{b} and R_{c} are 5 membered or 6 membered rings of the general formula

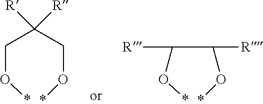

wherein, (*) indicates the position of attachment,
R′, and R′″ are C₁-C₄ alkyl, and
R″, and R″″ are C₁-C₄alkylene-hydroxy, C₄-C₃₂acyloxy, or C₄-C₃₂acyloxy-C₁-C₄alkylene;
R₁-R₄ each represent independently of one another C₁-C₆alkyl; and
R₅ and R₆ each represent independently of one another hydrogen, C₁-C₆alkyl or
C₆-C₁₀aryl; or
R₅ and R₆ together represent oxygen.

In a hydroxylamine ester of the formula (I), the term acyl with regard to the definition of Rₐ preferably represents an acyl radical selected from the group consisting of —C(═O)—H, —C(═O)—C₁C₁₉alkyl, —C(═O)—C₂-C₁₉alkenyl, —C(═O)—C₂-C₄alkenyl-C₆-C₁₀aryl, —C(═O)—C₆-C₁₀aryl, —C(═O)—O—C₁-C₆alkyl, —C(═O)—O—C₆-C₁₀aryl, —C(═O)—NH—C₁-C₆alkyl, —C(═O)—NH—C₆-C₁₀aryl and —C(═O)—N(C₁-C₆alkyl)₂;
C₁-C₁₉Alkyl in the acyl group Rₐ is, for example, C₁-C₆alkyl, e.g. methyl, ethyl, n-propyl or isopropyl or n-, sec- or tert-butyl or straight-chain or branched pentyl or hexyl, or C₇-C₁alkyl, e.g. straight-chain or branched heptyl, octyl, isooctyl, nonyl, tert-nonyl, decyl or undecyl, or straight-chain C₁₁-C₁₉alkyl, which together with the —(C═O)— radical forms C₁₂-C₂₀alkanoyl having an even number of C-atoms, e.g. lauroyl (C₁₂), myristoyl (C₁₄), palmitoyl (C₁₆) or stearoyl (C₁₈).

C₆-C₁₀Aryl is, for example, carbocyclic monoaryl or diaryl, preferably monoaryl, e.g., phenyl, which can be monosubstituted or disubstituted by suitable substituents, e.g., C₁-C₄alkyl, e.g., methyl, ethyl, or tert-butyl, C₁-C₄alkoxy, e.g., methoxy or ethoxy, or halogen, e.g., chlorine. In the case of disubstitution, the 2- and 6-positions are preferred.

The above-mentioned acyl radical Rₐ can be substituted on the free valences by suitable substituents, e.g., fluorine or chlorine, and is preferably formyl, acetyl, trifluoroacetyl, pivaloyl, acryloyl, methacryloyl, oleoyl, cinnamoyl, benzoyl, 2,6-xyloyl, tert-butoxycarbonyl, ethylcarbamoyl or phenylcarbamoyl.

C₁-C₆Alkyl as R₁-R₄ is preferably C₁-C₄alkyl, more preferably C₁-C₂alkyl, e.g., methyl or ethyl.

In preferred embodiments, R₁-R₄ are methyl or ethyl. Alternatively, from one to three substituents R₁-R₄ are ethyl. The remaining substituents are then methyl.

R₅ and R₆ are preferably hydrogen. C₁-C₆Alkyl or C₆-C₁₀aryl as R₅ and R₆ are preferably methyl or phenyl.

The hydroxylamine esters of the formula (I) are known or can be prepared by known methods, e.g., by acylation of the corresponding >N—OH compound in a customary esterification reaction with an acid Rₐ—OH that introduces the group Rₐ and corresponds to an acyl group selected, for example, from the group consisting of —C(═O)—H, —C(═O)—C₂-C₁₉alkyl,
—C(═O)—C₂-C₁₉alkenyl, —C(═O)—C₂-C₄alkenyl-C₆-C₁₀aryl, —C(═O)—C₆-C₁₀aryl, —C(═O)—O—C₁-C₆alkyl, —C(═O)—O—C₆-C₁₀aryl, —C(═O)—NH—C₁-C₆alkyl, —C(═O)—NH—C₆-C₁₀aryl and
—C(═O)—N(C₁-C₆alkyl)₂, or a reactive functional derivative thereof, e.g., the acid halide Rₐ—X, e.g., the acid chloride, or anhydride, e.g. (Rₐ)₂O. The hydroxylamine esters of the formula (I) and methods for their preparation are described in WO 01/90113.

In an embodiment, the hydroxylamine ester of the formula (I) is selected from sterically hindered amine derivatives of the formula (IA)

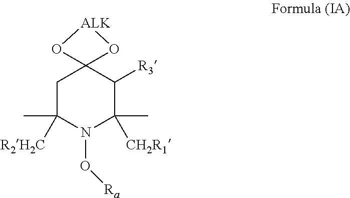

wherein, Rₐ represents acyl, R₁′, R₂′, and R₃′ are each, of one another, hydrogen, or methyl and ALK represents C₂-C₁₀alkylene or C₃-C₁₀alkylene substituted by at least one substituent selected from the group consisting of C₁-C₄alkylene-hydroxy, C₄-C₃₂acyloxy and C₄-C₃₂acyloxy-C₁-C₄alkylene.

Examples of alkylene having up to 10 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, and decyl.

Examples of acyloxy having up to 32 carbon atoms are acetyloxy, propanoyloxy, butanoyloxy, pentanoyloxy, and the like.

In a preferred embodiment, the hydroxylamine ester of the formula (I) is selected from the group consisting of sterically hindered amine derivatives of the formula (IA′)

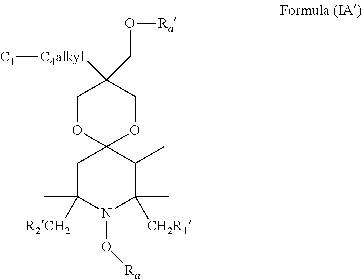

wherein R₁′ and R₂′ independently of one another represent hydrogen or methyl;
Rₐ represents C₂-C₈ acyl and
Rₐ′ represents C₈-C₂₂ acyl.

Examples of acyl having up to 22 carbon atoms are acetyl, propanoyl, butanoyl, pentanoyl, and the like.

In a more preferred embodiment, the hydroxylamine ester of the formula (I) is selected from sterically hindered amine derivatives of the formula (IA″)

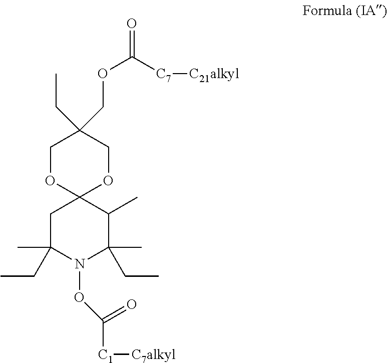

Examples of C₁ to C₂₁ alkyls are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, nonadecyl, icosanyl, and henicosanyl.

In a most preferred embodiment, the hydroxylamine ester of the formula (I) is a compound of formula (IA′″)

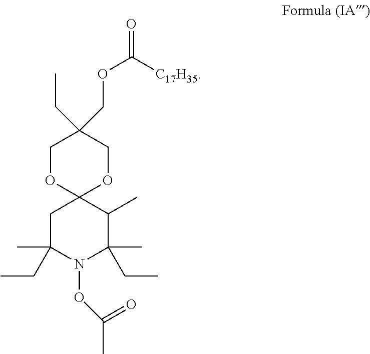

In an embodiment, the method of increasing drawability and/or melt strength and/or melt elasticity of the polyethylene comprising the step of mixing polyethylene, and a compound selected from polypropylene, 0.001 to 1 wt % of the hydroxylamine esters selected from sterically hindered amine of the formula (I), (IA), (IA′), (IA″), (IA′″), or mixtures of two or more thereof, as defined above, based on the total weight of the mixture, or a combination thereof.

In an embodiment, the step of mixing comprises mixing of the polypropylene and/or the hydroxylamine esters selected from sterically hindered amine of the formula (I), (IA), (IA′), (IA″), or (IA′″), or mixtures of two or more thereof, as defined above, with the polyethylene sequentially or at the same time.

In another embodiment, the step of mixing comprises mixing of the premixed polyethylene and polypropylene with the hydroxylamine esters selected from sterically hindered amine of the formula (I), (IA), (IA′), (IA″), or (IA′″), or mixtures of two or more thereof, as defined above.

In an embodiment, the weight ratio of the total amount of hydroxylamine esters selected from sterically hindered amine of the formula (I), (IA), (IA′), (IA″), (IA′″), or mixtures of two or more thereof, as defined above, to the total amount of polyethylene is in the range of from 0.001:99.999 to 0.05 to 99.95.

In a preferred embodiment, the weight ratio of the total amount of hydroxylamine esters selected from sterically hindered amine of the formula (I), (IA), (IA′), (IA″), (IA′″), or mixtures of two or more thereof, as defined above, to the total amount of polyethylene is in the range of from 0.01:99.99.

In a more preferred embodiment, the weight ratio of the total amount of hydroxylamine esters selected from sterically hindered amine of the formula (I), (IA), (IA′), (IA″), (IA′″), or mixtures of two or more thereof, as defined above, to the total amount of polyethylene is in the range of from 0.013:99.97.

In an embodiment, the weight ratio of the total amount of the compound selected from polypropylene, hydroxylamine esters selected from sterically hindered amine of the formula (I), (IA), (IA′), (IA″), (IA′″), or mixtures of two or more thereof, as defined above, or combination thereof to the total amount of polyethylene is in the range of from 0.01:99.99 to 10:90.

In a preferred embodiment, the weight ratio of the total amount of the compound selected from polypropylene, hydroxylamine esters selected from sterically hindered amine of the formula (I), (IA), (IA′), (IA″), (IA′″), or mixtures of two or more thereof, as defined above, or combination thereof to the total amount of polyethylene is in the range of from 0.01:99.99 to 6:94.

In an embodiment, the step of mixing further comprises an additive selected from light stabiliser, antioxidant, vis-breaking agents other than the hydroxylamine esters of formula (I), metal deactivators, phosphites and phosphonites, nitrones, thiosynergists, peroxide scavengers, basic co-stabilisers, nucleating agents, fillers and reinforcing agents, benzofuranones, indolinones, slip additives, acid scavengers, lubricants, polymer processing aids, anti-blocking additives, antifogging additives, activators, or mixtures of two or more thereof.

These additives are commonly used in the plastics' industry. Examples of slip additives, acid scavengers are described in Chapter 4 of the Plastic Additives Handbook; examples of lubricants are described in Chapter 5 of the Plastic Additives Handbook; polymer processing aids are described in Chapter 6 of the Plastic Additives Handbook; examples of anti-blocking additives are given in Chapter 7 of the Plastic Additives Handbook; and examples of antifogging additives are given in Chapter 9 of the Plastic Additives Handbook. Each refers to Plastic Additives Handbook, 5^{th} Edition, Edited by Hans Zweifel, Hanser Munich, ISBN 3-446-21654-5.

Specific examples of the above-mentioned additives are given below.
1. Antioxidants
1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′ methylheptadec-1′-yl)phenol, 2,4-dimethyl-6-(1′-methyltridec-1′-yl)phenol and mixtures thereof.
1.2. Alkylthiomethylphenols, for example 2,4-dioctylthiomethyl-6-tert-butylphenol, 2,4-dioctyl thiomethyl-6-methylphenol, 2,4-dioctylthiomethyl-6-ethylphenol, 2,6-di-dodecylthiomethyl-4-nonylphenol.
1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
1.4. Tocopherols, for example α-tocopherol, β-tocopherol, γ-tocopherol, δ-tocopherol, and mixtures thereof (vitamin E).
1.5. Hydroxylated thiodiphenyl ethers, for example 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.
1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl) phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tertbutyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.
1.7. 0-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tertbutylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxy benzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.
1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris (3,5-di-tertbutyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)hexahydro-1,3,5-triazine, 1,3,5-tris(3,5-dicyclohexyl-4-hydroxybenzyl)isocyanurate.
1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
1.12. Acylaminophenols, for example 4-hydroxylauranilide, 4-hydroxystearanilide, octyl N-(3,5-ditert-butyl-4-hydroxyphenyl)carbamate.
1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylol propane, 4-hydroxymethyl-1-phospha-2,6,7-trioxabicyclo[2.2.2]octane.
1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert butyl-4-hydroxy-5-methylphenyl)propionyloxy}-1,1-dimethylethyl]-2,4,8,10-tetraoxaspiro[5.5]undecane.
1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of β8-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).
1.18. Ascorbic acid (vitamin C)
1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenyl amine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N phenyl-1-naphthylamine, a mixture of mono and dialkylated tert-butyl/tert-octyldiphenyl amines, a mixture of mono- and dialkylated nonyldiphenylamines, a mixture of mono- and dialkylated dodecyldiphenylamines, a mixture of mono and dialkylated isopropyl/isohexyl diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tertoctyl-phenothiazines, N-allylphenothiazine, N,N,N′,N′-tetraphenyl-1,4-diaminobut-2-ene.
2. UV absorbers and light stabilizers
2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′ hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonyl ethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; −[—R—CH₂CH₂COO—CH₂CH₂-]₂—, where R=3′-tert-butyl-4′-hydroxy-5′-2H-benzotriazol-2-ylphenyl, 2-[2′-hydroxy-3′-(α, α-dimethylbenzyl)-5′-(1,1,3,3-tetramethylbutyl)-phenyl]benzotriazole; 2-[2′-hydroxy-3′-(1,1,3,3-tetramethylbutyl)-5′-(α,α-dimethylbenzyl)-phenyl]benzotriazole.
2.2. 2-Hydroxybenzophenones, for example the 4-hydroxy, 4-methoxy, 4-octyloxy, 4-decyl oxy, 4-dodecyloxy, 4-benzyloxy, 4,2′,4′-trihydroxy and 2′-hydroxy-4,4′-dimethoxy derivatives.
2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.
2.4. Acrylates/Cinnamates, for example ethyl α-cyano-β,β-diphenylacrylate, isooctyl α-cyano-ββ-diphenylacrylate, methyl α-carbomethoxycinnamate, methyl α-cyano-/β-methyl-p-methoxycinnamate, butyl α-cyano-β,β-methyl-p-methoxycinnamate, methyl α-carbomethoxy-p-methoxycinnamate, N-(β-carbomethoxy-β-cyanovinyl)-2-methylindoline, neopentyl tetra(α-cyano-β,β-diphenylacrylate. Other cyanoacrylates may also be used and such compounds are given in EP 3587425.
2.5. Nickel compounds, for example nickel complexes of 2,2′-thio-bis[4-(1,1,3,3-tetramethyl butyl)phenol], such as the 1:1 or 1:2 complex, with or without additional ligands such as n butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or with out additional ligands.
2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl) bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-noctyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-a-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl) oxymethyl-3,3,5-trimethyl-2-morpholinone, Sanduvor 3058 (Clariant; CAS Reg. No. 106917-31-1]1-(1-acetyl-2,2,6,6-tetramethylpiperidin-4-yl)-3-dodecylpyrrolidine-2,5-dione, the reaction product of 2,4-bis [(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl) amino)-s-triazine.
2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.
2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethyl phenyl)-1,3,5-triazine, 2-(2-hydroxy-4-hexyloxy)phenyl-4,6-diphenyl-1,3,5-triazine, 2-(2-hydr oxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.
3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.
4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecylpentaerythritol diphosphite, bis(2,4-di-tert-butylphenyl)pentaerythritol diphosphite, bis(2,4-di cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl) pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo [triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, poly(4,4′{-isopropylidenediphenol}-octylphosphite), poly(4,4′-{isopropylidenebis[2,6-dibromophenol]}-octylphosphite), poly(4,4′-{2,2′-dimethyl-5,5′-di-t-butylphenylsulfide}-pentaerythrityl diphosphite), phosphorous acid, mixed 2,4-bis(1,1-dimethylpropyl)phenyl and 4-(1,1-dimethylpropyl)phenyl triesters (CAS No. 939402-02-5), phosphorous acid, triphenyl ester, polymer with alpha-hydro-omega-hydroxypoly[oxy(methyl-1,2-ethanediyl)], C₁₀₋₁₆alkyl esters (CAS No. 1227937-46-3).

The following phosphites are especially preferred:
Tris(2,4-di-tert-butylphenyl) phosphite (Irgafos®168, BASF SE), tris(nonylphenyl) phosphite,

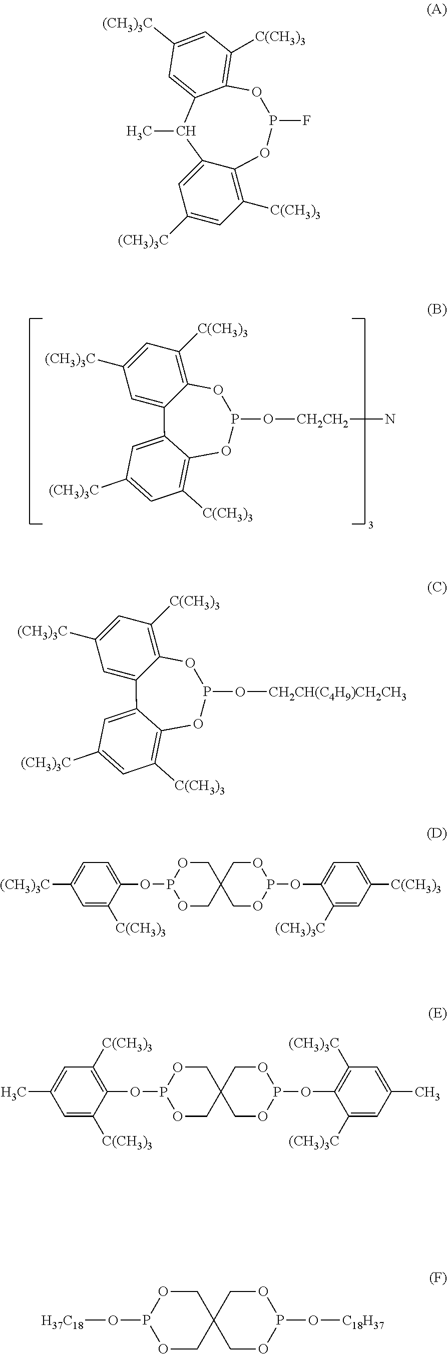

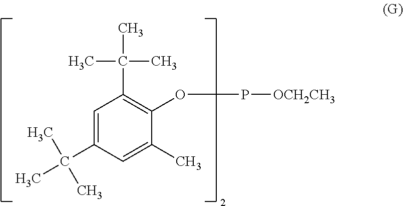

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N dihexadecylhydroxylamine, N,N-dioctadecylhydroxylamine, N-hexadecyl-N-octadecylhydrox ylamine, N-heptadecyl-N-octadecylhydroxylamine, N,N-dialkylhydroxylamine derived from hydrogenated tallow amine or derived from vegetable source.
6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-octadecyl-alpha-pentadecylnitrone, N-heptadecyl-alpha-hepta decylnitrone, N-octadecyl-alpha-hexadecylnitrone, nitrone derived from N,N-dialkylhydroxylamine derived from hydrogenated tallow amine.
7. Thiosynergists, for example dilauryl thiodipropionate, dimistryl thiodipropionate, distearyl thiodipropionate, pentaerythritol tetrakis[3-(dodecylthio)proponate] or distearyl disulfide.
8. Peroxide scavengers, for example esters of β-thiodipropionic acid, for example the lauryl, stearyl, myristyl or tridecyl esters, mercaptobenzimidazole or the zinc salt of 2-mercapto benzimidazole, zinc dibutyldithiocarbamate, dioctadecyl disulfide, pentaerythritol tetrakis(β8-dodecylmercapto)propionate.
9. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
10. Nucleating agents, for example inorganic substances, such as talcum, metal oxides, such as titanium dioxide or magnesium oxide, phosphates, carbonates, or sulfates of, preferably, alkaline earth metals; organic compounds, such as mono- or polycarboxylic acids and the salts thereof, e.g., 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.
11. Fillers and reinforcing agents, for example calcium carbonate, silicates, surface treated silica (as described e.g., in US-A-2007/60,697 and US-A-2009/111,918), glass fibers, glass beads, asbestos, talc, kaolin, mica, barium sulfate, metal oxides and hydroxides, carbon black, graphite, wood flour and flours or fibers of other natural products, synthetic fibers.
12. Other additives, for example plasticisers, lubricants, emulsifiers, pigments, rheology additives, catalysts, flow-control agents, optical brighteners, flameproofing agents, antistatic agents and blowing agents. Other additives may also include anti-block additives, as referred to above, which are used in films to reduce the negative adhesion of two polyethylene surfaces to one another which would otherwise result in difficulties separating the films. Further additives include slip additives, as referred to above, which are used to help the film surfaces slide over each other. Antifogging agents, as referred to above, may also be added.
13. Benzofuranones and indolinones, for example those disclosed in U.S. Pat. Nos. 4,325,863; 4,338,244; 5,175,312; 5,216,052; 5,252,643; DE-A-4316611; DE-A-4316622; DEA-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxy ethoxy)phenyl]benzofuran-2-one, 3,3′-bis[5,7-di-tert-butyl-3-(4-[2-hydroxyethoxy]phenyl)benzofuran-2-one], 5,7-di-tertbutyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctyl benzofuran-2-one. Suitable benzofuranones also include compounds identified in WO2015/121445 and WO2017/025431.

### 14. Vis-Breaking Agents

Vis-breaking agents or generally radical initiators. Typically, this includes organic or inorganic peroxides, which are widely used in industry, bis azo compounds, and cumenes,

### 14.1 Peroxides

Examples of suitable peroxides as vis-breaking agents include 2,5-dimethyl-2,5-di(t-butylperoxy)hexane, 2,5-dimethyl-2,5-di(t-butylperoxy)hexyne-3, 3,6,6,9,9-pentamethyl-3-(ethyl acetate)-1,2,4,5-tetraoxy cyclononane, t-butyl hydroperoxide, hydrogen peroxide, dicumyl peroxide, t-butyl peroxy isopropyl carbonate, di-t-butyl peroxide, p-chlorobenzoyl peroxide, dibenzoyldiperoxide, t-butyl cumyl peroxide; t-butyl hydroxyethyl peroxide, di-t-amyl peroxide and 2,5-dimethylhexene-2,5-diperisononanoate, acetylcyclohexanesulphonyl peroxide, diisopropyl peroxydicarbonate, tert-amyl perneodecanoate, tert-butyl-perneodecanoate, tert-butyl perpivalate, tert-amyl perpivalate, bis(2,4-dichlorobenzoyl) peroxide, diisononanoyl peroxide, didecanoyl peroxide, dioctanoyl peroxide, dilauroyl peroxide, bis(2-methylbenzoyl)peroxide, disuccinoyl peroxide, diacetyl peroxide, dibenzoyl peroxide, tert-butyl per-2-ethylhexanoate, bis(4-chlorobenzoyl) peroxide, tert-butyl perisobutyrate, tert-butyl permaleate, 1,1-bis(tert-butylperoxy)-3,5,5-trimethylcyclohexane, 1,1-bis(tert-butylperoxy)cyclohexane, tert-butyl peroxyisopropyl carbonate, tert-butyl perisononaoate, 2,5-dimethylhexane 2,5-dibenzoate, tert-butyl peracetate, tert-amyl perbenzoate, tert-butyl perbenzoate, 2,2-bis(tert-butylperoxy)butane, 2,2-bis(tert-butylperoxy)propane, dicumyl peroxide, 2,5-dimethylhexane 2,5-di-tert-butylperoxid, 3-tert-butylperoxy-3-phenyl phthalide, di-tert-amyl peroxide, α,α′-bis(tert-butylperoxyisopropyl) benzene, 3,5-bis(tert-butylperoxy)-3,5-di-methyl-1,2-dioxolane, di-tert-butyl peroxide, 2,5-dimethylhexyne 2,5-di-tert-butyl peroxide, 3,3,6,6,9,9-hexamethyl-1,2,4,5-tetraoxacyclononane, p-menthane hydroperoxide, pinane hydroperoxide, diisopropylbenzene mono-α-hydroperoxide, cumene hydroperoxide or tert-butyl hydroperoxide.

### 14.2. Bis Azo Compounds

Such azo compounds are for example 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 1, 1′-azobis(1-cyclohexanecarbonitrile), 2,2′-azobis(isobutyramide)dihydrate, 2-phenylazo-2,4-dimethyl-4-methoxyvaleronitrile, dimethyl 2,2′-azobisisobutyrate, 2-(carbamoylazo)isobutyronitrile, 2,2′-azobis(2,4,4-trimethylpentane), 2,2′-azobis(2-methylpropane), 2,2′-azobis(N,N′-dimethyleneisobutyramidine) as free base or hydrochloride, 2,2′azobis(2-amidinopropane) as free base or hydrochloride, 2,2′-azobis{2-methyl-N-[1, 1-bis(hydroxymethyl)ethyl]propionamide} or 2,2′-azobis{2-methyl-N-[1, 1-bis(hydroxymethyl)-2-hydroxyethyl]propionamide.

### 14.3 Cumenes

Examples of cumenes as vis-breaking agents include 2,3-dimethyl-2,3-diphenylbutane, or 3,4-dimethyl-3,4-diphenylhexane.

### 15. Activators

Examples of activators are thiols, disulfides, thioesters, or thiourethanes.

### 15.1 Thiols

Examples of thiols and dithiols as suitable activators are of the formulae

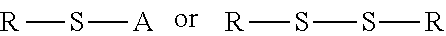

where
R is a mono, di, tri or tetravalent hydrocarbyl group attached to the sulfur atom with a carbon atom and A is hydrogen or —SO₃⁻B⁺ is an organic or inorganic cation.

Also included are thiouram sulfides, dithiocarbamates, mercaptobenzthiazoles and sulfenamides.

R, as hydrocarbyl which is attached to the sulfur atom with a carbon atom, is, for example, C₈-C₂₂alkyl, hydroxy-C₂-C₈alkyl, mercapto-C₂-C₈alkyl, mercapto-C₈-C₂₀alkyl interrupted by one or more —NH— groups, mercapto-C₈-C₂₀alkyl interrupted by one or more —OCO— groups, mercapto-C₈-C₁₈alkyl substituted by one or more hydroxyl groups, C₈-C₁₀aryl or is C₆-C₁₀aryl substituted by one or more substituents selected from the group consisting of C₁-C₄alkyl, 4-thiophenyl, 3-methyl-4-thiophenyl and C₆-C₁₀aryl-C₁-C₄alkyl.

A cation or a cationic group B⁺ is for example, an alkali metal cation, e.g. sodium or potassium ion, ammonium ion, tri-C₁-C₄alkylammonium ion, e.g. the tetramethyl- or tetraethylammonium ion, or the cholanyl cation.

In a preferred embodiment, the thiols and dithiols are octadecane thiol, pentaerythritol tetrakis(3-mercaptopropionate).

### 15.2 Thiourethanes:

Examples of Thiourethanes as suitable activators are of the formulae

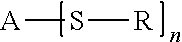

A is based on an organic isocyanate, wherein the radical(s) —S—R are introduced by reaction with isocyanate groups,
R is C₂-C₄₀ alkyl which is optionally substituted and/or interrupted, and
n is equal to or greater than 1.

A is preferably based on an organic isocyanate, which is a arylalkyldiisocyanate, aryl diisocyanate, isophorone diisocyanate, or diarylalkane diisocyanate each of which is unsubstituted or substituted by C₁-C₄ alkyl or di(C₁-C₄alkyl)amino, or is C₄-C₂₀alkyl diisocyanate, or an oligomeric or polymeric product obtained by reaction of the above diisocyanates with themselves and/or with a polyol.

A polyol is preferably C₁-C₁₀alkanol comprising two or more hydroxy groups, or a poly-C₂-C₁₀alkylene glycol.

Corresponding organic isocyanates are known or can be obtained according to known processes, for example from WO 05/070987.

R can, for example, be interrupted by —O—, —NH—, —S— and/or a carbonyl group. A possible substituent for R is —SH. Corresponding C₈-C₄₀alkyl, especially C₈-C₂₀alkyl, is preferred.

In view of the above, the term “isocyanates functionalized with thio compounds” relates to corresponding thiourethanes.

In an embodiment, the additive is present in the polymer melt in an amount of from 0.001 to 10 wt % based on the total weight of the polyethylene.

In a preferred embodiment, the additive is present in the polymer melt in an amount of from 0.001 to 5 wt % based on the total weight of the polyethylene.

In an embodiment, conventional fillers or reinforcing agents can be present in the polymer melt in amount of from 0.1 to 10% wt % based on the total weight of the polyethylene.

In a preferred embodiment, the conventional fillers or reinforcing agents can be present in an amount of from 1 to 5 wt % based on the total weight of the polyethylene.

In another aspect, the presently claimed invention is directed to a polyethylene composition comprising 80 to 99.8 wt % of polyethylene based on the total weight of the composition; and a compound selected from 0.1 to 10 wt % of a polypropylene based on the total weight of the composition, 0.001 to 1 wt % of hydroxylamine esters selected from sterically hindered amine of the formula (I), (IA), (IA′), (IA″), (IA′″), or mixtures of two or more thereof, as defined above, based on the total weight of the composition, or a combination thereof.

The polyethylene composition further comprising an additive selected from light stabiliser, antioxidant, vis-breaking agents other than the hydroxylamine esters of formula (I), metal deactivators, phosphites and phosphonites, nitrones, thiosynergists, peroxide scavengers, basic co-stabilisers, nucleating agents, fillers and reinforcing agents, benzofuranones, indolinones, slip additives, acid scavengers, anti-blocking additives, antifogging additives, activators, or mixtures of two or more thereof.

The polyethylene, polypropylene, and additives are selected from the group as defined above.

In yet another aspect, the present invention is directed to the use of polypropylene and/or hydroxylamine esters selected from sterically hindered amine of the formula (I), (IA), (IA′), (IA″), (IA′″), or mixtures of two or more thereof, as defined above for increasing the drawability and/or melt strength and/or melt elasticity of polyethylene.

In an embodiment, the polyethylene is a polyethylene film or fiber.

Thus, another aspect of the present invention is an article comprising the polyethylene composition as defined above.

In an embodiment, the articles are polyethylene films or fibers.

The presently claimed invention offers one or more of the following advantages:
1. A method for improving processibility of polyethylene.
2. A method for increasing drawability and/or melt strength and/or melt elasticity of polyethylene during processing, especially during the extrusion of polyethylene.

In the following, specific embodiments of the presently claimed invention are described:
1. A method for increasing drawability and/or melt strength and/or melt elasticity of polyethylene comprising the step of mixing the polyethylene with a compound selected from 0.1 to 10 wt % of polypropylene based on the total weight of the mixture, at least one hydroxylamine ester of the formula (I), or a combination thereof

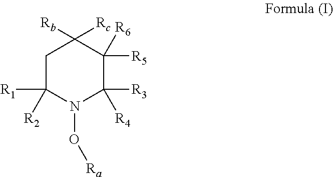

wherein Rₐ represents acyl;
one of R_{b} and R_{c} represents hydrogen, hydroxyl, or C₁-C₆alkyl and the other is C₁-C₆alkyl, C₁-C₆alkoxy, C₆-C₁₀aryloxy, acyloxy selected from the group consisting of —O—C(═O)—H, —OC(═O)—C₁-C₁₉alkyl, —O—C(═O)—C₁-C₅₄alkenyl, —O—C(═O)—C₆-C₁₀aryl, —O—C(═O)—C₁-C₃₆alkenyl-C₆-C₁₀aryl, —O—C(═O)—O—C₁-C₁₉alkyl, —O—C(═O)—O—C₆-C₁₀aryl, —O—C(═O)—NH—C₁-C₆alkyl, —OC(═O)—NH—C₆-C₁₀aryl and —O—C(═O)—N(C₁-C₆alkyl)₂, C₁-C₆alkylamino, di-C₁-C₆alkylamino, C₆-C₁₀arylamino, acylamino selected from the group consisting of —NH—C(═O)—H, —NH—C(═O)—C₁-C₁₉alkyl, —NH—C(═O)—C₁-C₅₄alkenyl, —NH—C(═O)—C₆-C₁₀aryl, —NH—C(═O)—C₁-C₃₆alkenyl-C₆-C₁₀aryl, —NH—C(═O)—O—C₁-C₁₉alkyl, —NH—C(═O)—O—C₆-C₁₀aryl, —NH—C(═O)—NH—C₁-C₆alkyl, —NHC(═O)—NH—C₆-C₁₀aryl and —NH—C(═O)—N(C₁-C₆alkyl)₂, diacylamino selected from the group consisting of —N[—C(═O)—C₁-C₁₉alkyl]₂ and —N[—C(═O)—C₆-C₁₀aryl]₂, or N-acyl-N—C₁-C₆alkylamino; or
R_{b} and R_{c} both represent hydrogen, hydroxyl, or identical or different substituents as defined above; or
R_{b} and R_{c} are 5 membered or 6 membered rings of the general formula

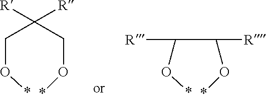

wherein, (*) indicates the position of attachment,
R′, and R′″ are C₁-C₄ alkyl, and
R″, and R″″ are C₁-C₄alkylene-hydroxy, C₄-C₃₂acyloxy, or C₄-C₃₂acyloxy-C₁-C₄alkylene;
R₁-R₄ each represent independently of one another C₁-C₆alkyl; and
R₅ and R₆ each represent independently of one another hydrogen, C₁-C₆alkyl, or
C₆-C₁₀aryl; or
R₅ and R₆ together represent oxygen.
2. The method according to embodiment 1, wherein increasing drawability and/or melt strength and/or melt elasticity of polyethylene comprises the step of mixing the polyethylene with 0.1 to 10 wt % of polypropylene based on the total weight of the mixture.
3. The method according to embodiment 1, wherein increasing drawability and/or melt strength and/or melt elasticity of polyethylene comprises the step of mixing the polyethylene with at least one hydroxylamine ester of the formula (I).
4. The method according to embodiment 1, wherein increasing drawability and/or melt strength and/or melt elasticity of polyethylene comprises the step of mixing the polyethylene with 0.001 to 1 wt % of at least one hydroxylamine ester of the formula (I) based on the total weight of the mixture.
5. The method according to embodiment 1, wherein increasing drawability and/or melt strength and/or melt elasticity of polyethylene comprises the step of mixing the polyethylene with polypropylene and at least one hydroxylamine ester of the formula (I).
6. The method according to any of the embodiments 1, 3, 4, and 5, wherein the hydroxylamine ester of the formula (I) is selected from sterically hindered amine derivatives of the formula (IA)

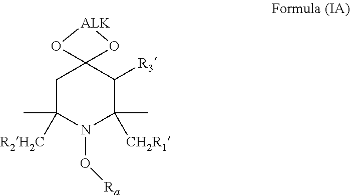

wherein, Rₐ represents acyl, R₁′, R₂′, and R₃′ are each, independently of one another, hydrogen, or methyl and ALK represents C₂-C₁₀alkylene or C₃-C₁₀alkylene substituted by at least one substituent selected from the group consisting of C₁-C₄alkylene-hydroxy, C₄-C₃₂acyloxy and C₄-C₃₂acyloxy-C₁-C₄alkylene.
7. The method according to any of the embodiments 1 to 6, wherein the hydroxylamine ester of the formula (I) is selected from sterically hindered amine derivatives of the formula (IA′)

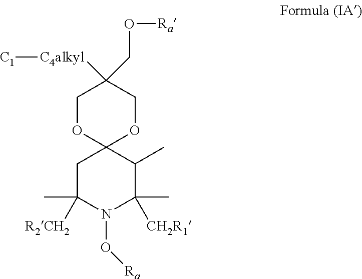

wherein R₁′ and R₂′ independently of one another represent hydrogen or methyl;
Rₐ represents C₂-C₅ acyl; and
Rₐ′ represents C₈-C₂₂ acyl.
8. The method according to any of the embodiments 1 to 7, wherein the hydroxylamine ester of the formula (I) is selected from sterically hindered amine derivatives of the formula (IA″)

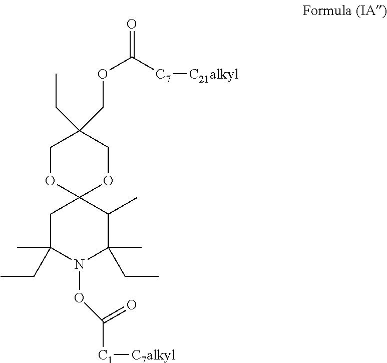

9. The method according to any of the embodiments 1 to 8, wherein the hydroxylamine ester of the formula (I) is a compound of formula (IA′″)

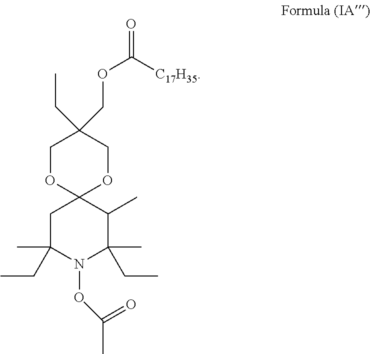

10. The method according to any of the embodiments 1 to 9, wherein increasing drawability and/or melt strength and/or melt elasticity of the polyethylene comprising the step of mixing the polyethylene, and a compound selected from polypropylene, 0.001 to 1 wt % of the hydroxylamine esters selected from sterically hindered amine of the formula (I), (IA), (IA′), (IA″), (IA′″), or mixtures of two or more thereof, as defined in embodiments 6 to 9, based on the total weight of the mixture, or a combination thereof.
11. The method according to any of the embodiments 1 to 10, wherein the step of mixing comprises mixing of the polypropylene and/or the hydroxylamine esters selected from sterically hindered amine of the formula (I), (IA), (IA′), (IA″), or (IA′″), or mixtures of two or more thereof, as defined in embodiments 6 to 9, with the polyethylene sequentially or at the same time.
12. The method according to any of the embodiments 1 to 11, wherein the polyethylene is ultrahigh molecular weight polyethylene (UHMWPE), ultra-low molecular weight polyethylene (ULMWPE or PE-WAX), high molecular weight polyethylene (HMWPE), high density polyethylene (HDPE), high density cross-linked polyethylene (HDXLPE), cross-linked polyethylene (PEX or XLPE), medium density polyethylene (MDPE), linear low density polyethylene (LLDPE), low density polyethylene (LDPE), very low density polyethylene (VLDPE) or chlorinated polyethylene (CPE).
13. The method according to any of the embodiments 1 to 12, wherein the polyethylene is linear low density polyethylene (LLDPE), or low density polyethylene (LDPE).
14. The method according to any of the embodiments 1 to 13, wherein the polyethylene has a density of from 0.910 to 0.960 g/cm³.
15. The method according to any of the embodiments 1 to 14, wherein the polyethylene is recyclate.
16. The method according to any of the embodiments 1 to 11, wherein the polypropylene is selected from the group consisting of polypropylene homopolymers, or polypropylene copolymers.
17. The method according to any of the embodiments 1 to 11, and 16, wherein the polypropylene has a melt flow index of greater than or equal to 0.5 g/10 min.
18. The method according to any of the embodiments 1 to 17, wherein the weight ratio of the total amount of polypropylene to the total amount of polyethylene is in the range of from 0.5:99.5 to 10:90.
19. The method according to any of the embodiments 1 to 17, wherein the weight ratio of the total amount of polypropylene to the total amount of polyethylene is in the range of from 1:99 to 5:95.
20. The method according to any of the embodiments 1 to 15, wherein the weight ratio of the total amount of hydroxylamine esters selected from sterically hindered amine of the formula (I), (IA), (IA′), (IA″), (IA′″), or mixtures of two or more thereof, as defined in embodiments 6 to 9, to the total amount of polyethylene is in the range of from 0.001:99.999 to 0.05 to 99.95.
21. The method according to any of the embodiments 1 to 15, wherein the weight ratio of the total amount of hydroxylamine esters selected from sterically hindered amine of the formula (I), (IA), (IA′), (IA″), (IA′″), or mixtures of two or more thereof, as defined in embodiments 6 to 9, to the total amount of polyethylene is in the range of from 0.01:99.99.
22. The method according to any of the embodiments 1 to 21, wherein the step of mixing further comprises an additive selected from light stabiliser, antioxidant, vis-breaking agents other than the hydroxylamine esters of formula (I), metal deactivators, phosphites and phosphonites, nitrones, thiosynergists, peroxide scavengers, basic co-stabilisers, nucleating agents, fillers and reinforcing agents, benzofuranones, indolinones, slip additives, acid scavengers, anti-blocking additives, antifogging additives, activators, or mixtures of two or more thereof.
23. A polyethylene composition comprising
   i. 80 to 99.8 wt % of polyethylene based on the total weight of the composition; and
   ii. A compound selected from 0.1 to 10 wt % of a polypropylene based on the total weight of the composition, 0.001 to 1 wt % of hydroxylamine esters selected from sterically hindered amine of the formula (I), (IA), (IA′), (IA″), (IA′″), or mixtures of two or more thereof, as defined in embodiments 6 to 9, based on the total weight of the composition, or combination thereof.
24. The polyethylene composition according to embodiment 23, wherein the polyethylene is ultrahigh molecular weight polyethylene (UHMWPE), ultra-low molecular weight polyethylene (ULMWPE or PE-WAX), high molecular weight polyethylene (HMWPE), high density polyethylene (HDPE), high density cross-linked polyethylene (HDXLPE), cross-linked polyethylene (PEX or XLPE), medium density polyethylene (MDPE), linear low density polyethylene (LLDPE), low density polyethylene (LDPE), very low density polyethylene (VLDPE), or chlorinated polyethylene (CPE).
25. The polyethylene composition according to any of the embodiments 23 and 24, wherein the polyethylene is linear low density polyethylene (LLDPE), or low density polyethylene (LDPE).
26. The polyethylene composition according to embodiment 23, wherein the polypropylene is polypropylene homopolymers, or polypropylene copolymers.
27. The polyethylene composition according to any of the embodiments 23 to 26 further comprises an additive selected from light stabiliser, antioxidant, vis-breaking agents other than hydroxylamine esters of formula (I), metal deactivators, phosphites and phosphonites, nitrones, thiosynergists, peroxide scavengers, basic co-stabilisers, nucleating agents, fillers and reinforcing agents, benzofuranones, indolinones, slip additives, acid scavengers, anti-blocking additives, antifogging additives, activators, or mixtures of two or more thereof.
28. The use of polypropylene and/or hydroxylamine esters selected from sterically hindered amine of the formula (I), (IA), (IA′), (IA″), (IA′″), or mixtures of two or more thereof, as claimed in any of the preceding claims for increasing the drawability and/or melt strength and/or melt elasticity of polyethylene.
29. The use according to embodiment 28, wherein the polyethylene is a polyethylene film or fiber.
30. An article comprising the polyethylene compositions as defined in any of the embodiments 23 to 27.
31. An article according to embodiment 30, wherein the articles are polyethylene films or fibers.

The following examples illustrate the invention in greater detail. All percentages and parts are by weight, unless stated otherwise.

### EXAMPLES

The additives used:
1. Polypropylene Evalene PHF0301 from JG Summit Olefins Corporation (PP1): MFI 3 g/cm³; density 0.900 g/cm³
2. Hydroxylamine ester: Compound of formula (IA′″):
   IUPAC Name: 9-Acetoxy-3,8,10-triethyl-7,8,10-trimethyl-1,5-dioxa-9-azaspiro[5,5]undec-3-yl-methylstearate

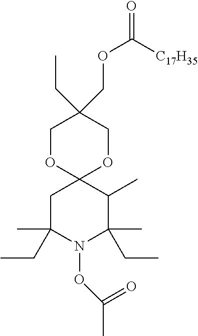

### Example 1

### Preparation:

Mixtures were produced using the additives as indicated above together with a 70/30 combination PE-LD (Riblene FC 30 ground) with PE-LLD (Dowlex SC 2108G ground) as basis in a high-speed mixer F35 MTU from the company MTI in Germany. The mixtures were compounded at 230° C. with a double screw compounding unit 25/42D from Collin in Germany to get well homogenized granules.

### Testing of Drawability and Melt Strength:

Drawability and melt strength of the compounds were tested with a rheotense test device connected with a single screw extruder from Gottfert in Germany.

The test temperature was 190° C. The sample was drawn uniaxially to a set of accelerating nips located 100 mm below the die, with an acceleration of 2.4 mm/s2. The tensile force (cN) was recorded as a function of the take-up speed of the nip rolls. The higher the value the better improvement in terms of melt strength.

Drawability was reported as the maximum ratio of drawing versus initial extrusion rate v/v₀ before appearance of draw resonance as an indication for draw turbulences and limit for increased throughput. Melt strength is the plateau force before the strand breaks. The higher the ratio v/v₀ (draw speed/initial extrusion speed at time zero) the better.

### Results

| | | Draw- | |
|---|---|---|---|
| | | ability | Melt |
| | | v/vₒ | strength |
| Test | Formulation | (—) | (cN) |
| Comparative 1 | Reference (no additives) | 4.6 | 0.19 |
| Comparative 2 | 1% PP1 | 4.8 | 0.22 |
| Comparative 3 | 5% PP1 | 4.8 | 0.22 |
| Comparative 4 | 0.013% Compound | 5.8 | 0.255 |
| | of formula (IA′″) | | |
| Inventive 1 | 1% PP1 + 0.013% | 8 | 0.26 |
| | Compound of formula (IA′″) | | |
| Inventive 2 | 5% PP1 + 0.013% | 7.8 | 0.255 |
| | Compound of formula (IA′″) | | |

The above results showed that the drawability and the melt strength of the so treated polyethylene according to the present invention is better than the reference formulation.

It is surprising that the addition of the compound of the formula (IA′″) does not lead to the expected decrease of melt strength due to degradation if polypropylene is present in the composition, see inventive examples 1 and 2 as compared to comparative example 4. It is in particular surprising that the drawability is significantly increased in the presence of both polypropylene and the compound of formula (IA′″), see inventive examples 1 and 2 as compared to comparative examples 1-4. This is even more surprising as the presence of the compound of formula (IA′″) is expected to lead to the degradation of polypropylene.

1. A method for increasing drawability and/or melt strength and/or melt elasticity of a polyethylene comprising mixing the polyethylene with 0.1 to 10 wt % of a polypropylene based on a total weight of a mixture, and at least one hydroxylamine ester of a formula (I) 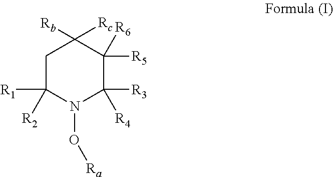
wherein Rₐ represents acyl;
one of R_{b} and R_{c} represents hydrogen, hydroxyl, or C₁-C₆alkyl and the other is C₁-C₆alkyl, C₁-C₆alkoxy, C₆-C₁₀aryloxy, acyloxy selected from the group consisting of —O—C(═O)—H, —O—C(═O)—C₁-C₁₉alkyl, —O—C(═O)—C₁-C₅₄alkenyl, —O—C(═O)—C₆-C₁₀aryl, —O—C(═O)—C₁-C₃₆alkenyl-C₆-C₁₀aryl, —O—C(═O)—O—C₁-C₁₉alkyl, —O—C(═O)—O—C₆-C₁₀aryl, —O—C(═O)NH—C₁-C₆alkyl, —O—C(═O)—NH—C₆-C₁₀aryl and —O—C(═O)—N(C₁-C₆alkyl)₂, C₁-C₆alkylamino, di-C₁-C₆alkylamino, C₆-C₁₀arylamino, acylamino selected from the group consisting of —NH—C(═O)—H, —NH—C(═O)—C₁-C₁₉alkyl, —NH—C(═O)—C₁-C₅₄alkenyl, —NHC(═O)—C₆-C₁₀aryl, —NH—C(═O)—C₁-C₃₆alkenyl-C₆-C₁₀aryl, —NH—C(═O)—O—C₁-C₁₉alkyl, —NH—C(═O)—O—C₆-C₁₀aryl, —NH—C(═O)—NH—C₁-C₆alkyl, —NH—C(═O)—NH—C₆-C₁₀aryl and —NH—C(═O)—N(C₁-C₆alkyl)₂, diacylamino selected from the group consisting of —N[—C(═O)C₁-C₁₉alkyl]2 and —N[—C(═O)—C₆-C₁₀aryl]2, or N-acyl-N—C₁-C₆alkylamino; or
R_{b} and R_{c} both represent hydrogen, hydroxyl, or identical or different substituents as defined above; or
R_{b} and R_{c} are 5 membered or 6 membered rings of a general formula 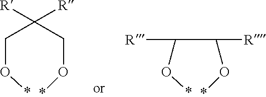
wherein, (*) indicates a position of an attachment,
R′, and R′″ are C₁-C₄ alkyl, and
R″, and R″″ are C₁-C₄alkylene-hydroxy, C₄-C₃₂acyloxy, or C₄-C₃₂acyloxy-C₁-C₄alkylene;
R₁-R₄ each represent independently of one another C₁-C₆alkyl; and
R₅ and R₆ each represent independently of one another hydrogen, C₁-C₆alkyl, or C₆-C₁₀aryl; or
R₅ and R₆ together represent oxygen.

2. The method according to claim 1, wherein increasing drawability and/or melt strength and/or melt elasticity of the polyethylene comprises the mixing the polyethylene with 0.001 to 1 wt % of the at least one hydroxylamine ester of the formula (I) based on the total weight of the mixture.

3. The method according to claim 1, wherein the
at least one hydroxylamine ester of the formula (I) is selected from a sterically hindered amine derivative of a formula (IA) 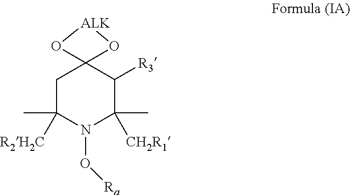
wherein, Rₐ represents acyl, R₁′, R₂′, and R₃′ are each, independently of one another, hydrogen, or methyl and ALK represents C₂-C₁₀alkylene or C₃-C₁₀alkylene substituted by at least one substituent selected from the group consisting of C₁-C₄alkylene-hydroxy, C₄-C₃₂acyloxy and C₄-C₃₂acyloxy-C₁-C₄alkylene.

4. The method according to claim 1, wherein the at least one hydroxylamine ester of the formula (I) is selected from a sterically hindered amine derivative of a formula (IA′) 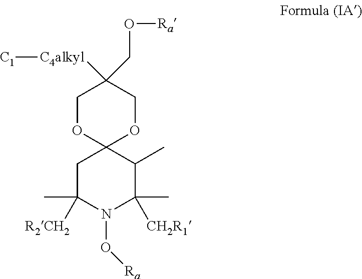
wherein R₁′ and R₂′ independently of one another represent hydrogen or methyl;
Rₐ represents C₂-C₈ acyl; and
Rₐ′ represents C₈-C₂₂ acyl.

5. The method according to claim 1, wherein the at least one hydroxylamine ester of the formula (I) is selected from a sterically hindered amine derivative of a formula (IA″)

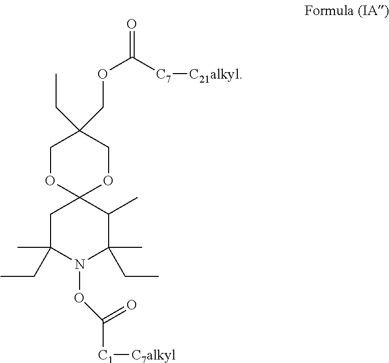

6. The method according to claim 1, wherein the at least one hydroxylamine ester of the formula (I) is a compound of a formula (IA′″)

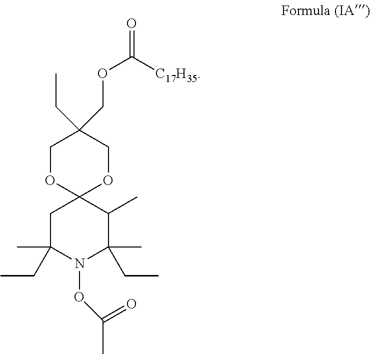

7. The method according to claim 1, wherein increasing drawability and/or melt strength and/or melt elasticity of the polyethylene comprising mixing the polyethylene, and a compound selected from the polypropylene, 0.001 to 1 wt % of the at least one hydroxylamine ester selected from a sterically hindered amine of a formula (I), (IA), (IA′), (IA″), (IA′″), 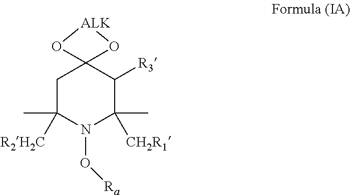
wherein R₁′, R₂′, and R₃′ are each, independently of one another, hydrogen, or methyl and ALK represents C₂-C₁₀alkylene or C₃-C₁₀alkylene substituted by at least one substituent selected from the group consisting of C₁-C₄alkylene-hydroxy, C₄-C₃₂acyloxy and C₄-C₃₂acyloxy-C₁-C₄alkylene, 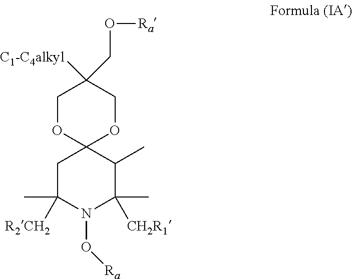
wherein Rₐ′ represents C₈-C₂₂ acyl, 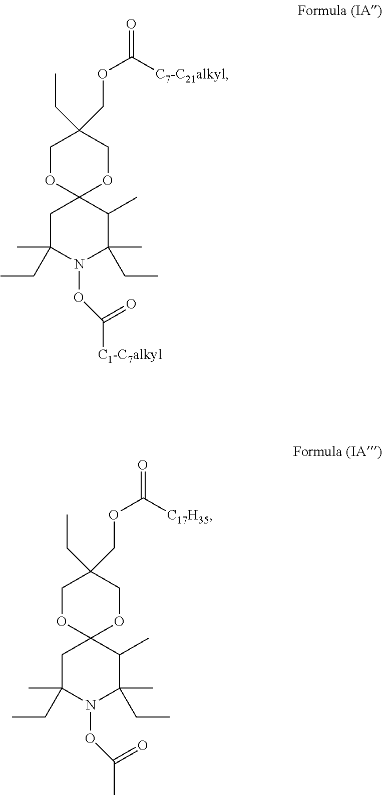
or a mixture of two or more thereof, based on the total weight of the mixture.

8. The method according to claim 1, wherein mixing comprises mixing of the polypropylene and/or the at least one hydroxylamine esters elected from a sterically hindered amine of a formula (I), (IA), (IA′), (IA″), or (IA′″), 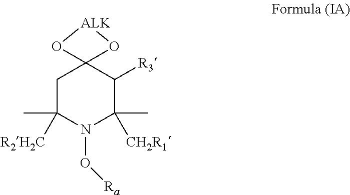
wherein R₁′, R₂′, and R₃′ are each, independently of one another, hydrogen, or methyl and ALK represents C₂-C₁₀alkylene or C₃-C₁₀alkylene substituted by at least one substituent selected from the group consisting of C₁-C₄alkylene-hydroxy, C₄-C₃₂acyloxy and C₄-C₃₂acyloxy-C₁-C₄alkylene, 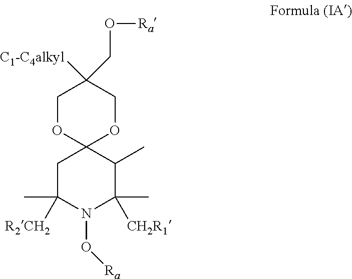
wherein Rₐ′ represents C₈-C₂₂ acyl, 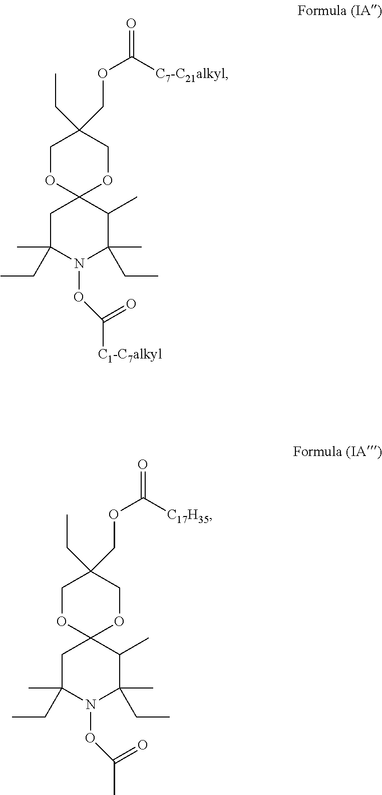
or a mixture of two or more thereof, with the polyethylene sequentially or at the same time.

9. The method according to claim 1, wherein the polyethylene is ultrahigh molecular weight polyethylene (UHMWPE), ultra-low molecular weight polyethylene (ULMWPE or PE-WAX), high molecular weight polyethylene (HMWPE), high density polyethylene (HDPE), high density cross-linked polyethylene (HDXLPE), cross-linked polyethylene (PEX or XLPE), medium density polyethylene (MDPE), linear low density polyethylene (LLDPE), low density polyethylene (LDPE), very low density polyethylene (VLDPE) or chlorinated polyethylene (CPE).

10. The method according to claim 1, wherein the polyethylene is linear low density polyethylene (LLDPE), or low density polyethylene (LDPE).

11. The method according to claim 1, wherein the polyethylene has a density from 0.910 to 0.960 g/cm³.

12. The method according to claim 1, wherein the polyethylene is a recyclate.

13. The method according to claim 1, wherein the polypropylene is selected from the group consisting of polypropylene homopolymers, or polypropylene copolymers.

14. The method according to claim 1, wherein the polypropylene has a melt flow index of greater than or equal to 0.5 g/10 min.

15. The method according to claim 1, wherein a weight ratio of the total amount of the polypropylene to the total amount of the polyethylene is in a range from 0.5:99.5 to 10:90.

16. The method according to claim 1, wherein a weight ratio of the total amount of the at least one hydroxylamine ester selected from a sterically hindered amine of a formula (I), (IA), (IA′), (IA″), (IA′″), 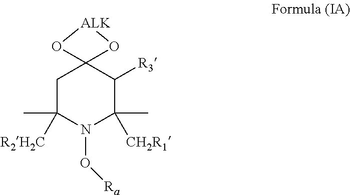
wherein R₁′, R₂′, and R₃′ are each, independently of one another, hydrogen, or methyl and ALK represents C₂-C₁₀alkylene or C₃-C₁₀alkylene substituted by at least one substituent selected from the group consisting of C₁-C₄alkylene-hydroxy, C₄-C₃₂acyloxy and C₄-C₃₂acyloxy-C₁-C₄alkylene, 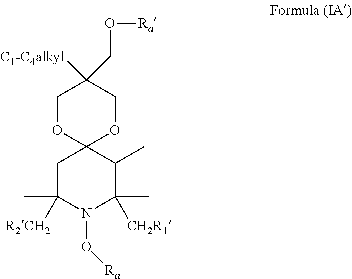
wherein Rₐ′ represents C₈-C₂₂ acyl, 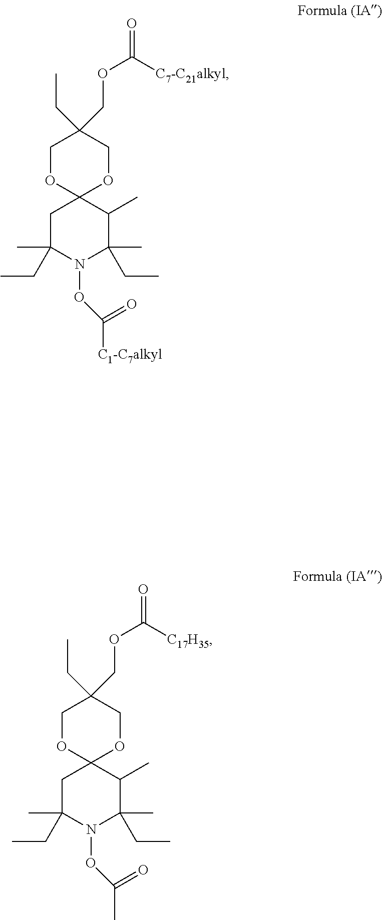
or a mixture of two or more thereof, to the total amount of the polyethylene is in a range from 0.001:99.999 to 0.05:99.95.

17. The method according to claim 1, wherein mixing further comprises an additive selected from a light stabiliser, an antioxidant, a vis-breaking agent other than the at least one hydroxylamine ester of the formula (I), a metal deactivator, a phosphite and a phosphonite, a nitrone, a thiosynergist, a peroxide scavenger, a basic co-stabiliser, a nucleating agent, a filler and a reinforcing agent, a benzofuranone, an indolinone, a slip additive, an acid scavenger, an anti-blocking additive, an antifogging additive, an activator, or a mixture of two or more thereof.

18. A polyethylene composition comprising
i. 80 to 99.8 wt % of a polyethylene based on a total weight of the composition; and
ii. a compound selected from 0.1 to 10 wt % of a polypropylene based on the total weight of the composition, 0.001 to 1 wt % of a hydroxylamine esters elected from a sterically hindered amine of a formula (I), (IA), (IA′), (IA″), (IA′″), 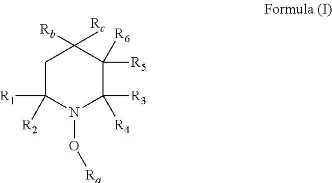
wherein Rₐ represents acyl;
one of R_{b} and R_{c} represents hydrogen, hydroxyl, or C₁-C₆alkyl and the other is C₁-C₆alkyl, C₁-C₆alkoxy, C₆-C₁₀aryloxy, acyloxy selected from the group consisting of —O—C(═O)—H, —O—C(═O)—C₁-C₁₉alkyl, —O—C(═O)—C₁-C₅₄alkenyl, —O—C(═O)—C₆-C₁₀aryl, —O—C(═O)—C₁-C₃₆alkenyl-C₆-C₁₀aryl, —O—C(═O)—O—C₁-C₁₉alkyl, —O—C(═O)—O—C₆-C₁₀aryl, —O—C(═O)NH—C₁-C₆alkyl, —O—C(═O)—NH—C₆-C₁₀aryl and —O—C(═O)—N(C₁-C₆alkyl)₂, C₁-C₆alkylamino, di-C₁-C₆alkylamino, C₆-C₁₀arylamino, acylamino selected from the group consisting of —NH—C(═O)—H, —NH—C(═O)—C₁-C₁₉alkyl, —NH—C(═O)—C₁-C₅₄alkenyl, —NHC(═O)—C₆-C₁₀aryl, —NH—C(═O)—C₁-C₃₆alkenyl-C₆-C₁₀aryl, —NH—C(═O)—O—C₁-C₁₉alkyl, —NH—C(═O)—O—C₆-C₁₀aryl, —NH—C(═O)—NH—C₁-C₆alkyl, —NH—C(═O)—NH—C₆-C₁₀aryl and —NH—C(═O)—N(C₁-C₆alkyl)₂, diacylamino selected from the group consisting of —N[—C(═O)C₁-C₁₉alkyl]₂ and —N[—C(═O)—C₆-C₁₀aryl]₂, or N-acyl-N—C₁-C₆alkylamino; or
R_{b} and R_{c} both represent hydrogen, hydroxyl, or identical or different substituents as defined above; or
R_{b} and R_{c} are 5 membered or 6 membered rings of a general formula 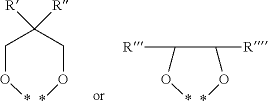
wherein, (*) indicates a position of an attachment,
R′, and R′″ are C₁-C₄ alkyl, and
R″, and R″″ are C₁-C₄alkylene-hydroxy, C₄-C₃₂acyloxy, or C₄-C₃₂acyloxy-C₁-C₄alkylene;
R₁-R₄ each represent independently of one another C₁-C₆alkyl; and
R₅ and R₆ each represent independently of one another hydrogen, C₁-C₆alkyl, or C₆-C₁₀aryl; or
R₅ and R₆ together represent oxygen, 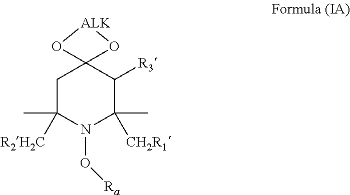
wherein R₁′, R₂′, and R₃′ are each, independently of one another, hydrogen, or methyl and ALK represents C₂-C₁₀alkylene or C₃-C₁₀alkylene substituted by at least one substituent selected from the group consisting of C₁-C₄alkylene-hydroxy, C₄-C₃₂acyloxy and C₄-C₃₂acyloxy-C₁-C₄alkylene, 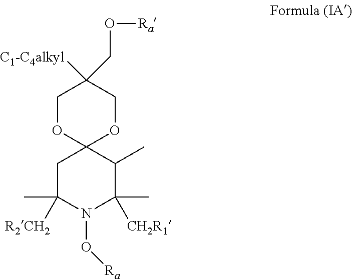
wherein Rₐ′ represents C₈-C₂₂ acyl, 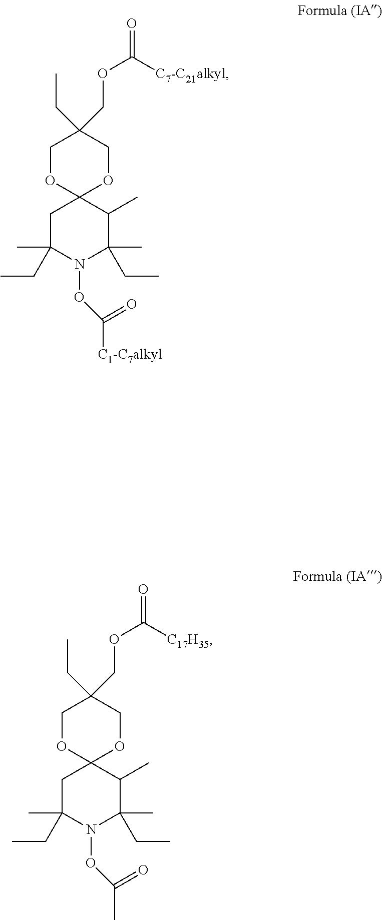
or a mixture of two or more thereof, based on the total weight of the composition, or a combination thereof.

19. The polyethylene composition according to claim 18 further comprises an additive selected from a light stabiliser, an antioxidant, a vis-breaking agent other than the hydroxylamine ester of the formula (I), a metal deactivator, phosphetane a phosphonite, a nitrone, a thiosynergist, a peroxide scavenger, abasic co-stabiliser, a nucleating agent, a filler and a reinforcing agent, a benzofuranone, an indolinone, a slip additive, an acid scavenger, an anti-blocking additive, an antifogging additive, an activator, or a mixture of two or more thereof.

20. A method for increasing the drawability and/or melt strength and/or melt elasticity of polyethylene, the method comprising mixing the polyethylene with the polypropylene and/or the hydroxylamine esters elected from a sterically hindered amine of a formula (I), (IA), (IA′), (IA″), (IA′″), 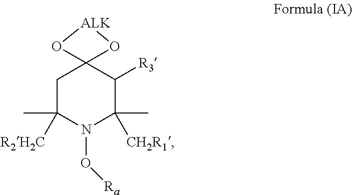
wherein R₁′, R₂′, and R₃′ are each, independently of one another, hydrogen, or methyl and ALK represents C₂-C₁₀alkylene or C₃-C₁₀alkylene substituted by at least one substituent selected from the group consisting of C₁-C₄alkylene-hydroxy, C₄-C₃₂acyloxy and C₄-C₃₂acyloxy-C₁-C₄alkylene, 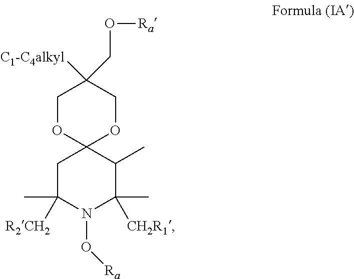
wherein Rₐ′ represents C₈-C₂₂ acyl, 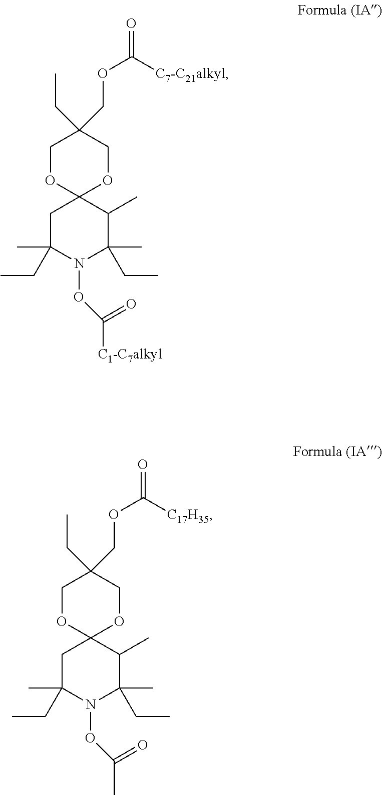
or a mixture of two or more thereof, as defined in claim 1.

21. The method according to claim 20, wherein the polyethylene is a polyethylene film or a fiber.

22. An article comprising the polyethylene composition as claimed in claim 18.

23. The article according to claim 22, wherein the article is a polyethylene film or a fiber.
